(19) United States
(12) Patent Application Publication
(10) Pub. No.: US 2026/0025613 A1
(43) Pub. Date: Jan. 22, 2026

(54) MICROPHONE AND WEARABLE ELECTRONIC DEVICE COMPRISING MICROPHONE

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Seeyoun KWON, Suwon-si (KR); Soogab Lee, Seoul (KR); Jihun Choi, Seoul (KR); Haekeu Park, Suwon-si (KR); Byeongmin Lee, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/347,171

(22) Filed: Oct. 1, 2025

Related U.S. Application Data
(63) Continuation of application No. PCT/KR2024/006481, filed on May 13, 2024.

(30) Foreign Application Priority Data
May 18, 2023 (KR) 10-2023-0064245
Aug. 2, 2023 (KR) 10-2023-0101127

(51) Int. Cl. H04R 1/10; H04R 1/08

(52) U.S. Cl. CPC H04R 1/1075; H04R 1/086; H04R 1/1016; H04R 1/1025; H04R 1/1083; H04R 2410/07; H04R 2460/01

(57) ABSTRACT

A wearable electronic device includes a housing including an opening in a surface thereof and a chamber defining a space facing the opening, a speaker inside the housing and configured to output sound toward a port at a position spaced apart from the opening, a grill at the opening, and a microphone configured to receive sound from outside the housing, where the chamber includes a first surface that is at least partially convex toward the opening and a hole at the first surface and configured to connect the space inside the chamber with the microphone.

### CROSS-REFERENCE TO RELATED APPLICATIONS

This application is a continuation of International Application No. PCT/KR2024/006481, filed on May 13, 2024, in the Korean Intellectual Property Receiving Office, which is based on and claims priority to Korean Patent Application No. 10-2023-0101127, filed on Aug. 2, 2023, in the Korean Intellectual Property Office, and Korean Patent Application No. 10-2023-0064245, filed on May 18, 2023, in the Korean Intellectual Property Office, the disclosures of which are incorporated by reference herein in their entireties.

### BACKGROUND

### 1. Field

The disclosure relates to a wearable electronic device and, for example, to a wearable electronic device including a microphone.

### 2. Description of Related Art

With advances in electronic technology, various types of wearable electronic devices have been miniaturized and equipped with diverse functions.

One or more sound effect-related components may be mounted on a printed circuit board of a wearable electronic device. The sound effect-related components may include, for example, a speaker and a microphone, and these components may be placed inside the housing of the wearable electronic device in various shapes and arrangements corresponding to the exterior design of the wearable electronic device that is designed in various ways.

The wearable electronic device including the speaker and the microphone may be, for example, an in-ear earphone (or an ear set, a headphone, or a headset) or a hearing aid. The wearable electronic device may be worn near a user's ear and may be manufactured in a compact size for this purpose.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, a wearable electronic device may include a housing including an opening in a surface thereof and a chamber defining a space facing the opening, a speaker inside the housing and configured to output sound toward a port at a position spaced apart from the opening, a grill at the opening, and a microphone configured to receive sound from outside the housing, where the chamber may include a first surface that is at least partially convex toward the opening and a hole at the first surface and configured to connect the space inside the chamber with the microphone.

The chamber may be recessed from the surface of the housing.

The chamber may include a second surface extending from the first surface toward the opening and a third surface extending from the first surface toward the opening and spaced apart from the second surface.

At least a portion of each of the second surface and the third surface may be straight.

The first surface may include a first portion extending in a first direction, a second portion extending in a second direction opposite to the first direction, the second portion being connected to the first portion, and an inflection portion at a position where the first portion and the second portion are connected.

The hole may be in the second portion.

The hole may be at least partially in the inflection portion.

A length of the first portion along the first direction may be equal to a length of the second portion along the second direction.

The first direction may correspond to to a flow direction of air that flows along the surface of the housing, and the hole may be in the second portion.

The hole may be at a position between the space of the chamber and the microphone, and may face a microphone hole of the microphone.

The first surface may face the grill.

The grill may include a plurality of through-holes through which air flowing along a surface of the housing flows.

A curvature of the first surface may be determined based on a portion of a surface of a spherical body formed by rotating an ellipse around a rotation axis.

An eccentricity of the ellipse may be within a range of 0.65 to 0.9.

The housing may include a first housing in which the microphone is provided, and a second housing in which the speaker is provided, where the chamber may be in the first housing.

According to an aspect of the disclosure, a wearable electronic device may include a housing including an opening and a chamber facing the opening, a grill on the opening, and a microphone below the chamber in a first direction, where the chamber may include a first surface that protrudes toward the opening in a second direction that is opposite to the first direction and a hole in the first surface at a position corresponding to the microphone and connecting the microphone with the chamber.

The first surface may be a curved surface including a first portion that curves towards the opening in a third direction intersecting the first direction, a second portion that curves toward the opening in a fourth direction that is opposite to the third direction, and an inflection portion where the first portion and the second portion meet.

The hole may be spaced apart from the inflection portion of the first surface in the third direction.

The hole may be at a position that includes the inflection portion.

According to an aspect of the disclosure, a wearable electronic device may include a housing including an opening and a chamber facing the opening, a grill on the opening, and a microphone below the chamber in a first direction, where the chamber may include a first surface having a curvature that protrudes toward the opening in a second direction that is opposite to the first direction, and a hole in the first surface at a position corresponding to the microphone and connecting the microphone with the chamber, where the curvature of the first surface is determined based on a portion of a surface of a spherical body formed by rotating an ellipse around a rotation axis, and an eccentricity of the ellipse is within a range of 0.65 to 0.9.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram of an electronic device according to various embodiments in a network environment;

FIG. 2 is a block diagram of an audio module according to various embodiments;

FIG. 3A is a perspective view of a wearable electronic device according to various embodiments of the disclosure;

FIG. 3B is a perspective view of the wearable electronic device according to various embodiments of the disclosure;

FIG. 4 is a view illustrating a portion of a wearable electronic device according to an embodiment of the disclosure;

FIG. 5 is a cross-sectional view of a wearable electronic device according to an embodiment of the disclosure;

FIG. 6 is a cross-sectional view of the wearable electronic device according to an embodiment of the disclosure;

FIG. 7 is a diagram illustrating components of FIG. 6 according to an embodiment of the disclosure;

FIG. 8 is a cross-sectional view of the wearable electronic device according to an embodiment of the disclosure.

FIG. 9A is a diagram of a portion of a cross-sectional view of a wearable electronic device according to a comparative example;

FIG. 9B is a diagram of a portion of a cross-sectional view of a wearable electronic device according to a comparative example;

FIG. 10 is a graph illustrating an effect of the wearable electronic device according to an embodiment of the disclosure;

FIG. 11A is a contour diagram illustrating a flow speed distribution in the wearable electronic device according to the comparative embodiment;

FIG. 11B is a contour diagram illustrating a flow speed distribution in the wearable electronic device according to the embodiment of the disclosure;

FIG. 12 is a domain for a computer simulation of noise values in the wearable electronic device according to the embodiment of the disclosure; and

FIG. 13 is a graph comparing values from a B-diagram of FIG. 10 with computer simulation results from FIG. 12, according to an embodiment of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

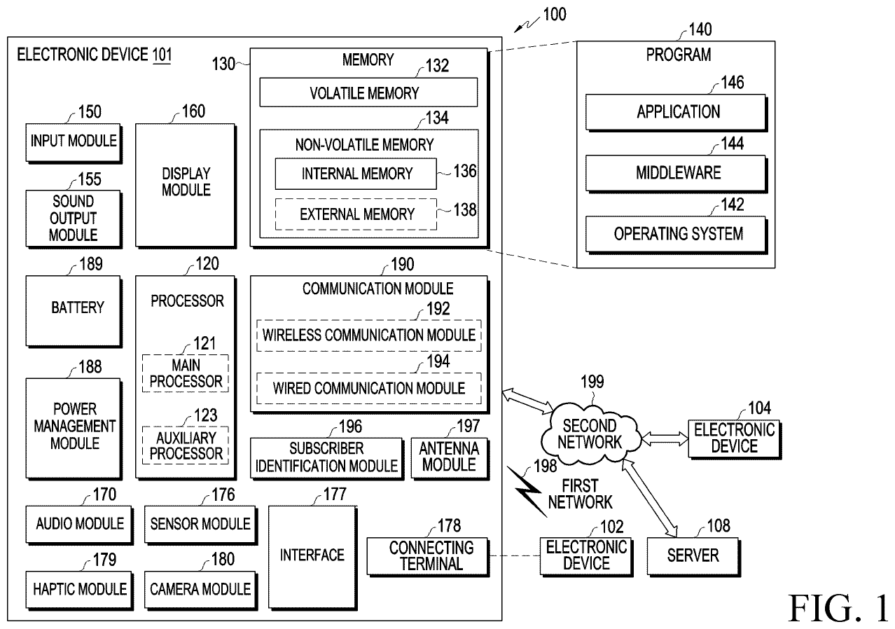

FIG. 1 is a block diagram illustrating an electronic device in a network environment according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

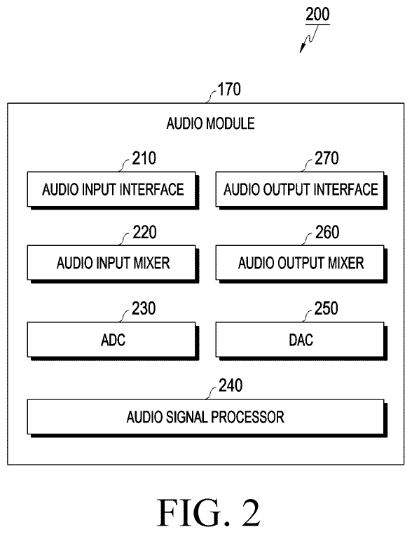

FIG. 2 is a block diagram 200 illustrating the audio module 170 according to various embodiments. Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

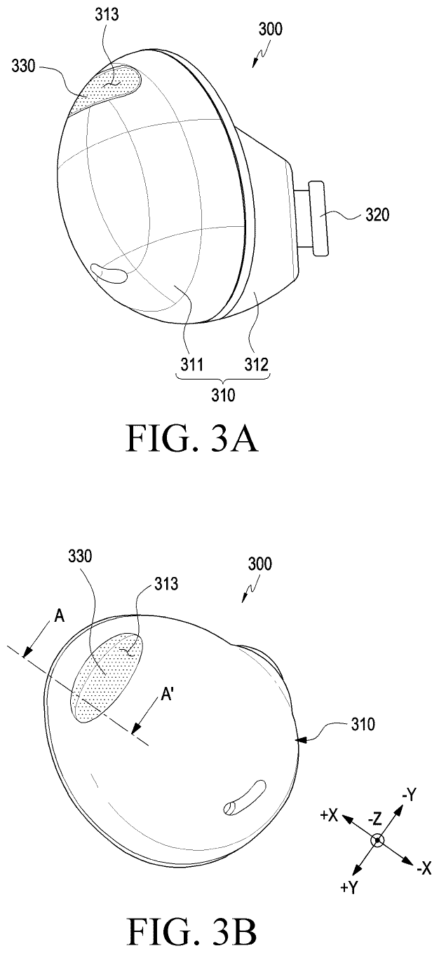

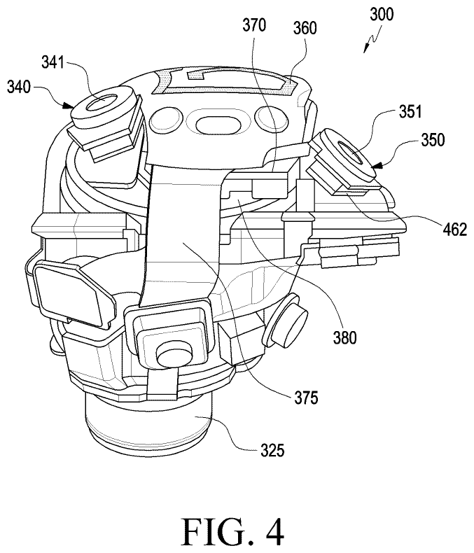

FIG. 3A is a perspective view of a wearable electronic device 300 according to an embodiment of the disclosure as viewed from one direction. FIG. 3B is a perspective view of the wearable electronic device 300 according to an embodiment of the disclosure as viewed from a different direction than FIG. 3A. Some or all of the components described with reference to FIGS. 3A and 3B may be the same as those described with reference to FIGS. 1 and 2. Some or all of the components described with reference to FIGS. 3A and 3B may also be the same as those described with reference to FIGS. 4 to 13.

According to an embodiment, the wearable electronic device 300 may include a housing 310. The housing 310 may form the exterior of the wearable electronic device 300. The housing 310 may be configured to be worn on a user's ear. The housing 310 may have a curved surface.

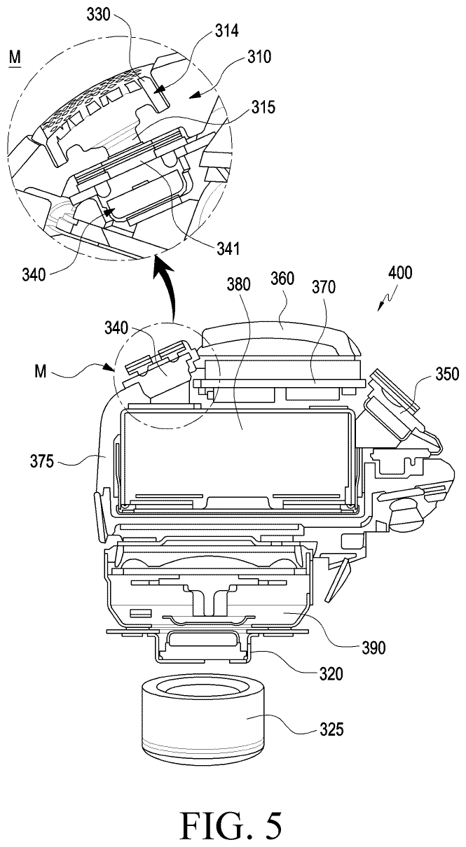

According to an embodiment, the housing 310 may include a first housing 311. The housing 310 may include a second housing 312. The first housing 311 and the second housing 312 may be integrally formed. An antenna (e.g., the antenna 360 of FIG. 5), a first circuit board (e.g., the first circuit board 370 of FIG. 5), a battery (e.g., the battery 380 of FIG. 5), and microphones (e.g., the microphones 340 and 350 of FIG. 5) may be disposed inside the first housing 311. A speaker (e.g., speaker 390 of FIG. 5) may be disposed inside the second housing 312.

According to an embodiment, the wearable electronic device 300 may include a port 320. The port 320 may protrude to the outside of the housing 310. The port 320 may be coupled to a second housing 312. The sound output from the speaker (e.g., the speaker 390 of FIG. 5) may be transmitted to the outside of the housing 310 through the port 320.

According to an embodiment, the housing 310 may include an opening 313. The opening 313 may be formed as an opening on a surface of the housing 310. The opening 313 may be formed in the first housing 311. Sound from the outside of the housing 310 may be transmitted to the inside of the housing 310 through the opening 313.

According to an embodiment, the wearable electronic device 300 may include a grill 330. The grill 330 may be disposed at the opening 313. The grill 330 may be coupled to the housing 310. The grill 330 may filter out foreign substances directed toward the opening 313.

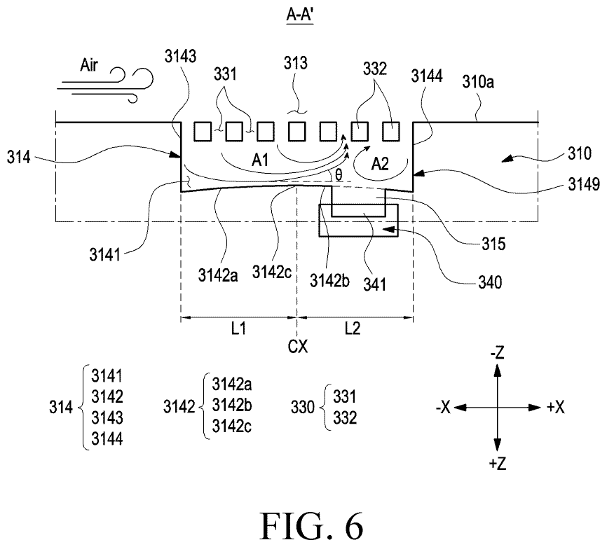

According to an embodiment, air flowing along a surface of the housing 310 may flow into the opening 313. A flow generated outside the housing 310 (e.g., wind) may form a laminar flow in one direction (e.g., the +X direction in FIG. 3B) along the surface of the housing 310. A portion of the flow (flux) formed along the surface of the housing 310 may flow into the chamber (e.g., 314 of FIG. 6) through the opening 313.

FIG. 4 illustrates a state in which the housing (e.g., the housing 310 of FIG. 3A) of the wearable electronic device 300 according to an embodiment of the disclosure is removed. FIG. 5 is a cross-sectional view of the structure illustrated in FIG. 4. Some or all of the components described with reference to FIGS. 4 and 5 may be the same as those described with reference to FIGS. 1 to 3B. Some or all of the components described with reference to FIGS. 4 and 5 may also be the same as those described with reference to FIGS. 6 to 13.

According to an embodiment, the wearable electronic device 300 may include microphones 340 and 350. In an embodiment, a plurality of microphones 340 and 350 may be provided. For example, the microphones 340 and 350 may include a first microphone 340 and/or a second microphone 350. The first microphone 340 and the second microphone 350 may be spaced apart from each other. The first microphone 340 and the second microphone 350 may collectively be referred to as “microphones.” The microphones 340 and 350 may receive sound from outside the housing (e.g., the housing 310 of FIG. 3A). For example, the microphones 340 and 350 may perform an active noise cancellation (ANC) function. For example, the microphones 340 and 350 may be disposed inside the first housing (e.g., the first housing 311 of FIG. 3A). The microphones 340 and 350 may include microphone holes 341 and 351. The first microphone 340 may include a first microphone hole 341. The second microphone 350 may include a second microphone hole 351. The microphones 340 and 350 may receive sound from outside the housing (e.g., the housing 310 of FIG. 3A) through the microphone holes 341 and 351. For example, air (e.g., wind) flowing outside the housing (e.g., the housing 310 of FIG. 3A) may flow into the microphones 340 and 350 through the microphone holes 341 and 351, and the microphones 340 and 350 may detect sound generated by the flow of air.

According to an embodiment, the microphone 340 may receive sound from outside the housing 310. Region M illustrated in FIG. 5 is an enlarged view of an area near the microphone 340 in the cross-sectional view of the wearable electronic device 300, with the housing 310 being depicted. The wearable electronic device 300 may include a chamber 314. The housing 310 may include a grill 330. The wearable electronic device 300 may include a hole 315 in communication with the microphone hole 341 of the microphone 340. Sound from outside the housing 310 may be received by the microphone 340 through the chamber 314 and the hole 315. Descriptions of the above components (e.g., the chamber 314 or the hole 315) will be provided later with reference to FIGS. 6 to 13.

According to an embodiment, the wearable electronic device 300 may include an antenna 360. The antenna 360 may be disposed inside the first housing (e.g., the first housing 311 of FIG. 3A). The antenna 360 may transmit and/or receive signals through the housing (e.g., the housing 310 of FIG. 3A).

According to an embodiment, the wearable electronic device 300 may include a first circuit board 370. For example, the first circuit board 370 may be electrically connected to the microphones 340 and 350, the antenna 360, a second circuit board 375, a battery 380, and/or a speaker 390.

According to an embodiment, the wearable electronic device 300 may include the second circuit board 375. The second circuit board 375 may be electrically connected to the first circuit board 370. The second circuit board 375 may connect the first circuit board 370 to the microphones 340 and 350. The second circuit board 375 may connect the first circuit board 370 to the battery 380. The second circuit board 375 may connect the first circuit board 370 to the speaker 390. The second circuit board 375 may include a flexible printed circuit board.

According to an embodiment, the wearable electronic device 300 may include a battery 380. The battery 380 may be disposed inside the first housing (e.g., the first housing 311 of FIG. 3A). The battery 380 may supply power to the microphones 340 and 350 and the speaker 390.

According to an embodiment, the wearable electronic device 300 may include a speaker 390. The speaker 390 may be disposed inside the second housing (e.g., the second housing 312 of FIG. 3A). The speaker 390 may output sound to the outside of the housing (e.g., the housing 310 of FIG. 3A).

According to an embodiment, the wearable electronic device 300 may include an ear tip 325. The ear tip 325 may be inserted into a user's ear. The ear tip 325 may be fixed to the port 320.

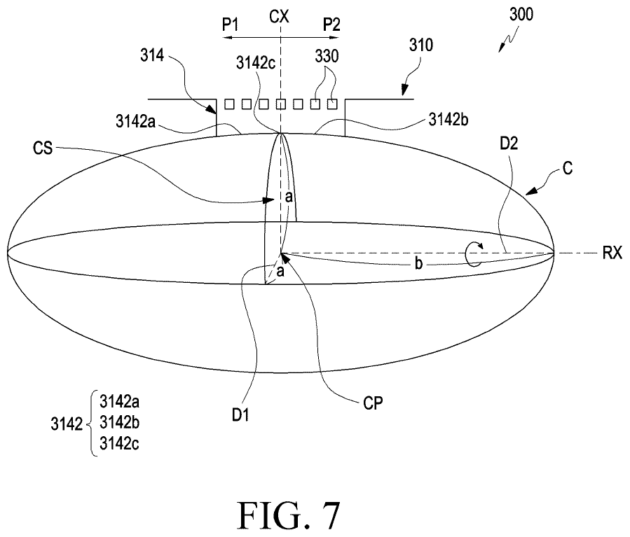

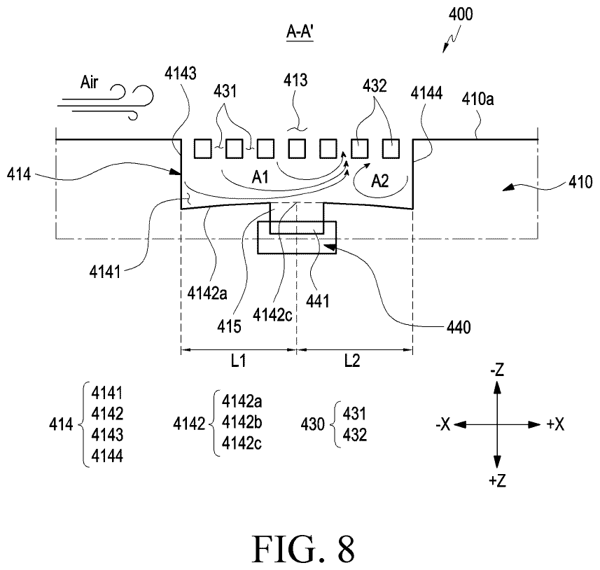

FIG. 6 is a cross-sectional view of the wearable electronic device 300 taken along line A-A′ of FIG. 3B according to an embodiment. FIG. 6 may conceptually illustrate some components for convenience of description. FIG. 7 is a diagram in which a virtual three-dimensional object C is illustrated in FIG. 6. The components to be described with reference to FIGS. 6 and 7 may be partially or wholly the same as the components described with reference to FIGS. 1 to 5. The components to be described with reference to FIGS. 6 and 7 may be partly or wholly the same as the components to be described with reference to FIGS. 8 to 13.

According to an embodiment, the wearable electronic device 300 may include a housing 310, a grill 330, and a microphone 340. The descriptions of the above components (e.g., the housing 310, the grill 330, and the microphone 340) may be substantially equally applicable to the descriptions of the components (e.g., the housing 310, the grill 330, and the microphone 340) described with reference to FIGS. 1 to 5.

According to an embodiment, the housing 310 may include an outer surface 310a. The outer surface 310a may form a surface of the housing 310. Air outside the housing 310 may flow along the outer surface 310a. The housing 310 may include an opening 313. In particular, the opening 313 may be formed, and the grill 330 may be formed in the opening 313. The opening 313 may be formed by partially opening the outer surface 310a. A portion of the air flowing along the outer surface 310a may flow into the chamber 314 through the opening 313.

According to an embodiment, the grill 330 may be disposed at the opening 313. The grill 330 may include a plurality of through-holes 331 and a plurality of solid portions 332. The plurality of through-holes 331 may be spaced apart from one another with the plurality of solid portions 332 therebetween. A portion of the air flowing along the outer surface 310a of the housing 310 may flow into the chamber 314 through the through-holes 331 of the grill 330.

According to an embodiment, the housing 310 may include a chamber 314. The chamber 314 may define a space 3141 in the housing 310. For example, the chamber 314 may be recessed into the outer surface 310a of the housing 310. The chamber 314 may be a portion of the housing 310. The space 3141 may face the opening 313. The space 3141 may face the grill 330. According to an embodiment, the chamber 314 may be defined by the housing 310 and the grill 330. For example, the chamber 314 may include the opening 313 and the space 3141. The grill 330 may be disposed in the space 3141 defined by the chamber 314. The chamber 314 may be referred to as a “groove.” The chamber 314 may be referred to as a “recess.” The chamber 314 may be referred to as a “groove portion.”

According to an embodiment, the chamber 314 may include a space 3141. The space 3141 may be connected to the opening 313. The space 3141 may be in communication with the outside of the housing 310. A portion of the air flowing along the outer surface 310a of the housing 310 may flow into the space 3141. The air introduced into the space 3141 may be discharged to the outside of the housing 310 through the opening 313 (e.g., through the through-holes 331 of the grill 330).

According to an embodiment, the chamber 314 may include a first surface 3142. The first surface 3142 may face the opening 313. The first surface 3142 may be spaced apart from the grill 330. The space 3141 may be defined between the first surface 3142 and the grill 330. The first surface 3142 may be formed convexly toward the opening 313. That is, the first surface 3142 may protrude toward the opening 313 (i.e., toward the grill 330). The first surface 3142 may have a curved shape. The first surface 3142 may be referred to as a “guide surface.”

According to an embodiment, the chamber 314 may include a second surface 3143. The second surface 3143 may extend from the first surface 3142 to the opening 313 of the housing 310.

According to an embodiment, the chamber 314 may include a third surface 3144. The third surface 3144 may extend from the first surface 3142 to the opening 313 of the housing 310.

According to an embodiment, each of the second surface 3143 and the third surface 3144 may be a portion of a peripheral surface 3149 of the chamber 314. For example, the chamber 314 may have a cylindrical peripheral surface 3149, and each of the second surface 3143 and the third surface 3144 may form an arch-shaped surface that is a portion of the peripheral surface 3149 of the chamber 314. For example, the second surface 3143 and the third surface 3144 may be different portions on the peripheral surface 3149 of the chamber 314. For example, the second surface 3143 and the third surface 3144 may be defined as a pair of portions facing each other on the peripheral surface 3149 of the chamber 314. The space 3141 of the chamber 314 may be defined between the second surface 3143 and the third surface 3144.

According to an embodiment, the first surface 3142 may include a first portion 3142a. The first portion 3142a may extend in a curved manner toward the opening 313. The first surface 3142 may include a second portion 3142b. The second portion 3142b may extend in a curved manner toward the opening 313. The first portion 3142a and the second portion 3142b may be connected. The first surface 3142 may include an inflection portion 3142c. The inflection portion 3142c may be formed at a position where the first portion 3142a and the second portion 3142b are connected (e.g., where the first portion 3142a and the second portion 3142b meet). The first portion 3142a, the second portion 3142b, and the inflection portion 3142c may be integrally formed. The inflection portion 3142c may form a vertex of the convex first surface 3142. The first portion 3142a may extend in a first direction (e.g., the +X direction) and may be curved toward the opening 313 along the first direction. The second portion 3142b may extend in a second direction opposite to the first direction (e.g., the −X direction) and may be curved toward the opening 313 along the second direction. The first surface 3142 may be convex in a third direction (e.g., the −Z direction) intersecting the first and second directions (e.g., the +X and −X directions). The third direction may be a direction facing outward from the housing 310. An airflow formed outside the housing 310 may flow along the outer surface 310a of the housing 310 and may form a laminar flow in the first direction (e.g., the +X direction).

According to an embodiment, the first portion 3142a and the second portion 3142b may be distinguished relative to a center line CX or a center plane CS illustrated in FIG. 7. For example, the first portion 3142a and the second portion 3142b may be defined as portions of the first surface 3142 that are located in different directions relative to a center line CX passing through a center point CP. For example, the first portion 3142a may be a portion of the first surface 3142 located in a first direction P1 relative to the center line CX. For example, the second portion 3142b may be a portion of the first surface 3142 located in a second direction P2 relative to the center line CX. According to an embodiment, the first portion 3142a and the second portion 3142b may be defined as portions of the first surface 3142 that are located in different directions relative to a center plane CS including the center line CX. For example, the first portion 3142a may be a portion of the first surface 3142 extending in a first direction P1 relative to the center plane CS. For example, the second portion 3142b may be a portion of the first surface 3142 extending in a second direction P2 relative to the center plane CS. According to an embodiment, the first portion 3142a and the second portion 3142b may be distinguished by the flow direction of air. For example, referring to FIG. 6, the first portion 3142a may be a portion of the first surface 3142 located upstream of the second portion 3142b. For example, referring to FIG. 6, the second portion 3142b may be a portion of the first surface 3142 located downstream of the first portion 3142a.

According to an embodiment, the housing 310 may include a hole 315. The hole 315 may be formed as an opening in the first surface 3142 of the chamber 314. For example, the hole 315 may be formed as an opening in a portion of the housing 310. The chamber 314 may be a portion of the housing 310 recessed into a surface of the housing 310, and the hole 315 may be formed in the recessed portion of the housing 310. The housing 310 may include the chamber 314 formed on a surface thereof and the hole 315 that is open from the chamber 314 toward the microphone 340. The hole 315 may be open in a fourth direction (e.g., the +Z direction). The hole 315 may extend from the first surface 3142 of the chamber 314 toward the inside of the housing 310 (e.g., in the +Z direction). The hole 315 may be formed in the second portion 3142b of the first surface 3142. The hole 315 may be formed at a position spaced apart from the inflection portion 3142c in the first direction (+X direction). The hole 315 may connect the space 3141 inside the chamber 314 to a microphone hole 341 of the microphone 340. Sound from outside the housing 310 may be received through the space 3141 and the hole 315 into the microphone hole 341. The chamber 314 may be positioned between the opening 313 and the microphone 340. The hole 315 may connect the chamber 314 and the microphone 340. The hole 315 may be referred to as a “channel.” The hole 315 may be referred to as a “passage.”

According to an embodiment, air introduced into the chamber 314 may form airflows A1 and A2 inside the space 3141. A portion of the air introduced into the chamber 314 may flow along the first portion 3142a to form a first airflow A1, and the remaining portion may flow along the second portion 3142b to form a second airflow A2. The wearable electronic device 300 according to various embodiments of the disclosure may reduce the phenomenon in which noise generated by airflow is transmitted to the microphone 340 through the hole 315 by guiding the airflow toward the outside of the housing 310 along the first surface 3142 formed convexly toward the opening 313. The first portion 3142a may be referred to as a “first guide portion.” The second portion 3142b may be referred to as a “second guide portion.”

According to an embodiment, the length L1 of the first portion 3142a and the length L2 of the second portion 3142b may be equal. However, the lengths L1 and L2 of the first portion 3142a and the second portion 3142b may differ from each other, and the length L1 of the first portion 3142a may be greater than the length L2 of the second portion 3142b.

According to an embodiment, and referring to FIG. 7, the curvature of the first surface 3142 may be determined based on a portion of the surface of a spherical body C obtained by rotating an ellipse about a rotation axis RX. The ellipse, which lies on the same plane as the rotation axis RX of the spherical body C, may have a minor axis D1 and a major axis D2 with respect to the center CP of the ellipse. The length a of the minor axis D1 may be smaller than the length b of the major axis D2. The eccentricity e according to Equation (1) of the ellipse defined by the lengths a and b of the minor axis D1 and the major axis D2 may have a value within a range of 0.65 to 0.9.

$$e = {( 1 - {a}^{2} / {b}^{2} )}^{1 / 2} \qquad ( 1 )$$

According to an embodiment, the first surface 3142 may be a curved surface. For example, the first surface 3142 may be a portion of the surface of a spherical body obtained by rotating a circle about the rotation axis RX. For example, the spherical body may be a sphere. However, the definition of the first surface 3142 is not limited to the above, and may be defined as a curved surface having a predetermined curvature. Additionally, the first surface 3142 may be a V shaped surface, with the first portion 3142a having a linear slope that increases in the +X direction, and a second portion 3142b having a linear slope that decreases in the +X direction.

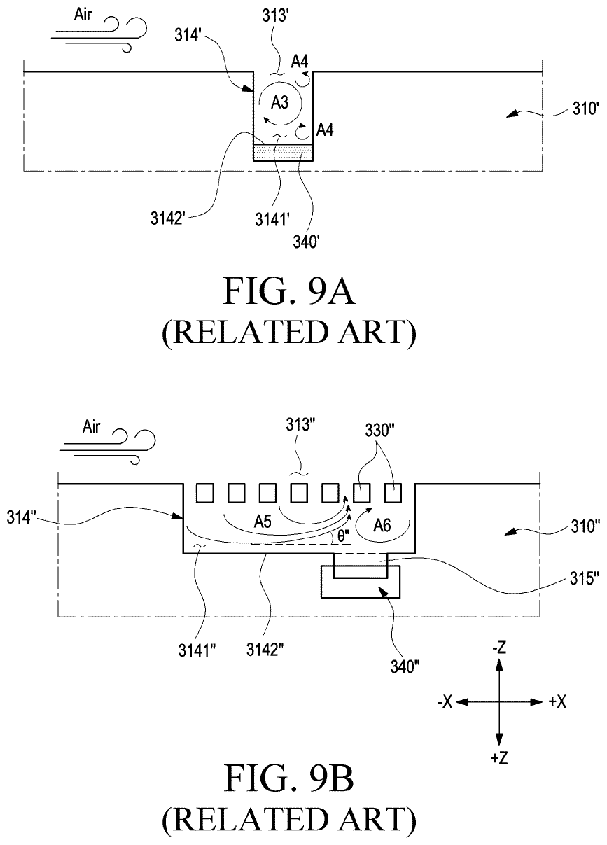

FIG. 8 is a cross-sectional view of the wearable electronic device 300 taken along line A-A′ of FIG. 3B. FIG. 8 may conceptually illustrate some components for convenience of description. The components to be described with reference to FIG. 8 may be partially or wholly the same as the components described with reference to FIGS. 1 to 7. The components to be described with reference to FIG. 8 may be partly or wholly the same as the components to be described with reference to FIGS. 9A to 13.

According to an embodiment, the wearable electronic device 400 may include a housing 410, a grill 430, and a microphone 440. The descriptions of the above components (e.g., the housing 410, the grill 430, and the microphone 440) may be substantially equally applicable to the descriptions of the components (e.g., the housing 310, the grill 330, and the microphone 340) described with reference to FIGS. 1 to 5. For example, the housing 410 may include an outer surface 410a, and the description of the outer surface 410a may be substantially equally applicable to the description of the outer surface 310a provided with reference to FIG. 6. For example, the grill 430 may include a plurality of through-holes 431 and a plurality of solid portions 432, and the description thereof may be substantially equally applicable to the description of the grill 330 provided with reference to FIG. 6.

According to an embodiment, the housing 410 may include an opening 413 and a chamber 414. The descriptions of the above components (e.g., the opening 413 and the chamber 414) may be substantially equally applicable to the descriptions of the components (e.g., the opening 313 and the chamber 314) provided with reference to FIG. 6. For example, the chamber 414 may include a space 4141 defined therein, a first surface 4142 formed convexly toward the opening 413, a second surface 4143 extending from the first surface 4142, and a third surface 4144 extending from the first surface 4142. The descriptions of the above components (e.g., the space 4141, the first surface 4142, the second surface 4143, or the third surface 4144) may be substantially equally applicable to the descriptions of the components (e.g., the space 3141, the first surface 3142, the second surface 3143, or the third surface 3144) provided with reference to FIG. 6.

According to an embodiment, the first surface 4142 may include a first portion 4142a, a second portion 4142b, and an inflection portion 4142c. The descriptions of the above components (e.g., the first portion 4142a, the second portion 4142b, and the inflection portion 4142c) may be substantially equally applicable to the descriptions of the components (e.g., the first portion 3142a, the second portion 3142b, and the inflection portion 3142c) provided with reference to FIG. 6.

According to an embodiment, the housing 410 may include a hole 415. The hole 415 may be formed as an opening in the first surface 4142 of the chamber 414. The hole 415 may be open in a fourth direction (e.g., the +Z direction). The hole 415 may extend from the first surface 4142 of the chamber 414 toward the inside of the housing 410 (e.g., in the +Z direction). The hole 415 may be formed at a position that includes the inflection portion 4142c of the first surface 4142. The hole 415 may be formed such that a center thereof corresponds to the inflection point of the inflection portion 4142c, and the hole 415 may be formed to be offset from the inflection point of the inflection portion 4142c but that still includes the inflection point of the inflection portion 4142c. The hole 415 may connect the space 4141 inside the chamber 414 to a microphone hole 441 of the microphone 440. Sound from outside the housing 410 may be received through the space 4141 and the hole 415 into the microphone hole 441. The chamber 414 may be positioned between the opening 413 and the microphone 440. The hole 415 may connect the chamber 414 and the microphone 440. The hole 415 may be referred to as a “channel.” The hole 415 may be referred to as a “passage.”

FIG. 9A is a diagram illustrating airflow inside a chamber 314′ according to a first comparative example. FIG. 9B is a diagram illustrating airflow inside a chamber 314″ according to a second comparative example.

According to the first comparative example (e.g., FIG. 9A), the chamber 314′ of the housing 310′ includes a flat surface 3142′. The flat surface 3142′ is located between a space 3141′ of the chamber 314′ and a microphone 340′. The opening 313′ in the first comparative example has a smaller width than the opening (e.g., the opening 313 of FIG. 6) according to an embodiment of the disclosure. Air introduced into the space 3141′ through the opening 313′ forms vortices A3 and A4 inside the space 3141′, and noise generated by the vortices A3 and A4 is transmitted to the microphone 340′.

According to the second comparative example (e.g., FIG. 9B), the chamber 314″ of the housing 310″ includes a flat surface 3142″. The flat surface 3142″ is located between a space 3141″ of the chamber 314″ and a microphone 340″. Air introduced into the space 3141″ through the opening 313″ and the grille 330″ forms airflows A5 and A6. An inclination angle (e.g., θ″) at which the airflows A5 and A6 formed in the second comparative example (e.g., FIG. 9B) are directed toward the opening 313″ may be smaller than an inclination angle (e.g., θ) at which the airflows (e.g., A1 and A2) formed inside the chamber (e.g., 314 in FIG. 6) according to an embodiment of the disclosure are directed toward the opening (e.g., 313 in FIG. 6). Air introduced into the chamber (e.g., 314 in FIG. 6) according to an embodiment of the disclosure may be diffracted toward the opening (e.g., 313 in FIG. 6) after colliding with the first surface (e.g., 3142 in FIG. 6) of the chamber (e.g., 314 in FIG. 6). The diffraction angle (e.g., θ) of the air according to an embodiment of the disclosure may be greater than the diffraction angle (e.g., θ″) of the air in the comparative examples. Air introduced into the chamber 314″ in the second comparative example may have a longer residence time inside the chamber than air introduced into the chamber (e.g., 314 in FIG. 6) according to an embodiment of the disclosure. The air introduced into and residing in the chamber 314″ may transmit noise to the microphone 340″ through a hole 315″ configured to connect the chamber 314″ and the microphone 340″.

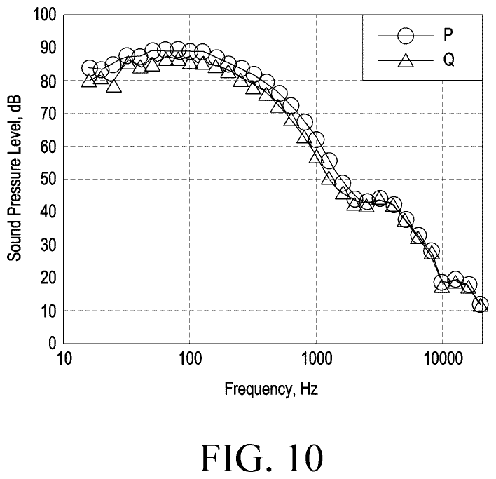

FIG. 10 is a graph comparing a noise measurement value Q received by the microphone 340 when the chamber 314 has the shape according to the embodiment of FIG. 6, and a noise measurement value P received by the microphone 340″ when the chamber 314″ has the shape according to the comparative example of FIG. 9B. Referring to FIG. 10, it may be seen that when the first surface 3142 of the chamber 314 has a convex shape toward the opening 313 as illustrated in FIG. 6, the generated noise is reduced.

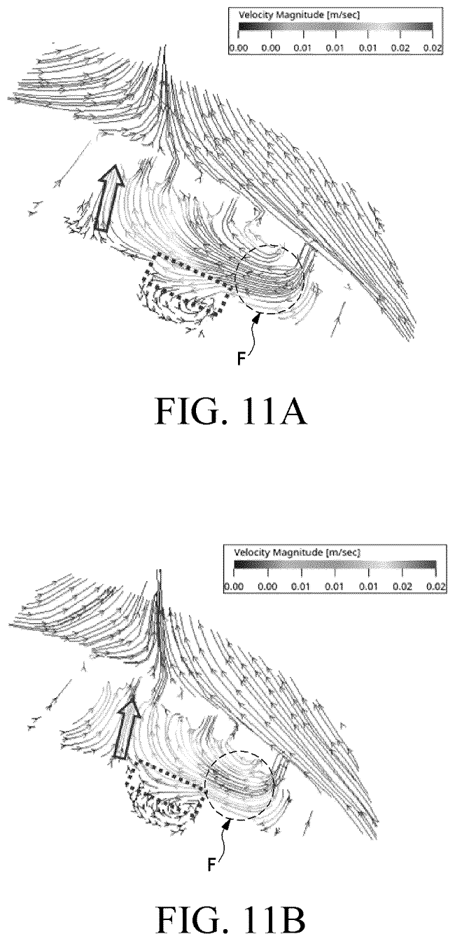

FIG. 11A is a contour diagram illustrating the airflow inside the chamber 314″ when the chamber 314″ has the shape according to the example of FIG. 9B. FIG. 11B is a contour diagram illustrating the airflow inside the chamber 314 when the chamber 314 has the shape according to the embodiment of FIG. 6. Referring to FIGS. 11A and 11B, it may be seen that the flow amount F when the chamber 314 has the shape according to the embodiment of the disclosure is smaller than the flow amount F″ when the chamber 314″ has the shape according to the comparative example.

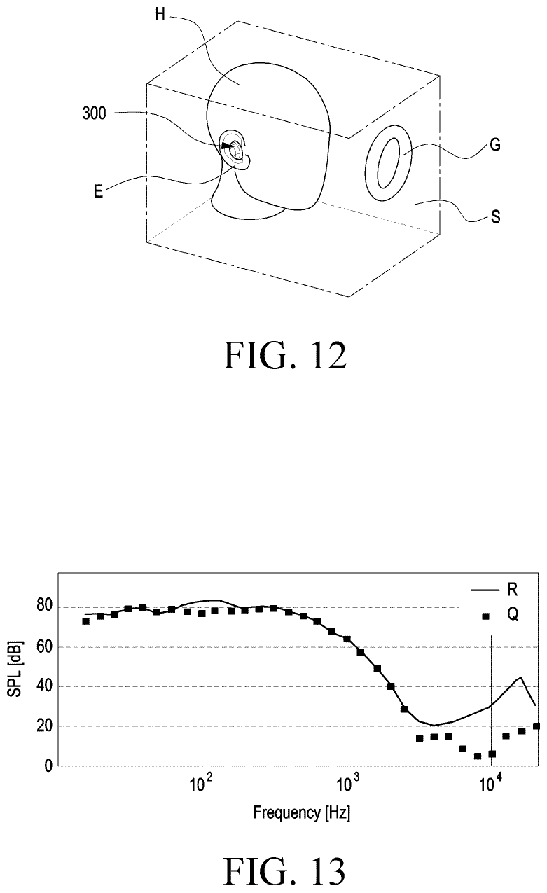

FIG. 12 is a diagram illustrating a computer simulation domain for noise measurement of the wearable electronic device 300 according to an embodiment of the disclosure. FIG. 13 is a graph comparing the computer simulation result R obtained from the domain of FIG. 12 and the experimental data Q obtained from a real use environment illustrated in FIG. 10 according to an embodiment. The computer simulation domain S illustrated in FIG. 12 includes a generator G that generates an airflow toward a person H and the wearable electronic device 300 worn on the ear E of the person H. Referring to FIG. 13, it may be seen that the noise measurement result R obtained through computer simulation and the noise measurement data Q obtained in a real use environment have approximate values.

The wearable electronic device includes a housing worn on the user's ear and a speaker disposed inside the housing to output sound to the user's ear. The wearable electronic device may include a microphone for active noise cancellation (ANC) functionality. A portion of wind flowing outside the housing may enter the microphone and cause airflow noise.

One of the problems to be solved by the disclosure may be to reduce the airflow noise received by the microphone.

Another problem to be solved by the disclosure may be to reduce the influence of airflow noise on the microphone while minimizing structural changes to the housing.

The issues that the disclosure seeks to address are not limited to the aforementioned issued, and may be expanded in various ways without departing from the spirit and scope of the disclosure.

According to various embodiments of the disclosure, the electronic device may reduce airflow noise received by the microphone by forming the first surface of the chamber, which faces the opening, to be convex toward the opening.

According to various embodiments of the disclosure, the electronic device may reduce noise received by adjusting the position of the hole connected to the microphone in accordance with the direction of airflow outside the housing.

According to an embodiment of the disclosure, a wearable electronic device (e.g., 300 or 400 of FIGS. 3A to 8) may include a housing (e.g., 310 or 410 of FIGS. 3A to 8) including an opening (e.g., 313 or 413 of FIGS. 3A to 8) formed in a surface thereof and a chamber (e.g., 314 or 414 of FIGS. 3A to 8) defining a space (e.g., 3141 or 4141 of FIGS. 3A to 8) facing the opening (e.g., 313 or 413 of FIGS. 3A to 8).

According to an embodiment of the disclosure, the wearable electronic device (e.g., 300 or 400 of FIGS. 3A to 8) may include a speaker (e.g., 390 of FIGS. 3A to 8) disposed inside the housing (e.g., 310 or 410 of FIGS. 3A to 8) and configured to output sound toward a port (e.g., 320 of FIGS. 3A to 8) disposed at a position spaced apart from the opening (e.g., 313 or 413 of FIGS. 3A to 8).

According to an embodiment of the disclosure, the wearable electronic device (e.g., 300 or 400 of FIGS. 3A to 8) may include a grill (e.g., 330 or 430 of FIGS. 3A to 8) disposed at the opening (e.g., 313 or 413 of FIGS. 3A to 8).

According to an embodiment of the disclosure, the wearable electronic device (e.g., 300 or 400 of FIGS. 3A to 8) may include a microphone (e.g., 340 or 440 of FIGS. 3A to 8) configured to receive sound from outside the housing (e.g., 310 or 410 of FIGS. 3A to 8).

According to an embodiment of the disclosure, the chamber (e.g., 314 or 414 of FIGS. 3A to 8) may include a first surface (e.g., 3142 or 4142 of FIGS. 3A to 8), which is at least partially formed convexly toward the opening (e.g., 313 or 413 of FIGS. 3A to 8).

According to an embodiment of the disclosure, the chamber (e.g., 314 or 414 of FIGS. 3A to 8) may include a hole (e.g., 315 or 415 of FIGS. 3A to 8) formed at the first surface (e.g., 3142 or 4142 of FIGS. 3A to 8) and configured to connect the space (e.g., 3141 or 4141 of FIGS. 3A to 8) inside the chamber (e.g., 314 or 414 of FIGS. 3A to 8) and the microphone (e.g., 340 or 440 of FIGS. 3A to 8).

According to an embodiment of the disclosure, the chamber (e.g., 314 or 414 of FIGS. 3A to 8) may be recessed from a surface of the housing (e.g., 310 of FIGS. 3A to 8).

According to an embodiment of the disclosure, the chamber (e.g., 314 or 414 of FIGS. 3A to 8) may include a second surface (e.g., 3143 of FIGS. 3A to 8) extending from the first surface (e.g., 3142 of FIGS. 3A to 8) toward the opening (e.g., 313 of FIGS. 3A to 8).

According to an embodiment of the disclosure, the chamber (e.g., 314 or 414 of FIGS. 3A to 8) may include a third surface (e.g., 3144 of FIGS. 3A to 8) extending from the first surface (e.g., 3142 of FIGS. 3A to 8) toward the opening (e.g., 313 of FIGS. 3A to 8) and spaced apart from the second surface (e.g., 3143 of FIGS. 3A to 8).

According to an embodiment of the disclosure, at least a portion of the first surface (e.g., 3142 of FIGS. 3A to 8) may be curved, and at least a portion of each of the second surface (e.g., 3143 of FIGS. 3A to 8) and the third surface (e.g., 3144 of FIGS. 3A to 8) may be flat or straight.

According to an embodiment of the disclosure, the first surface (e.g., 3142 or 4142 of FIGS. 3A to 8) may include a first portion (e.g., 3142a or 4142a of FIGS. 3A to 8) extending in a curved manner toward the opening (e.g., 313 or 413 of FIGS. 3A to 8) along a first direction (e.g., +X of FIGS. 3A to 8).

According to an embodiment of the disclosure, the first surface (e.g., 3142 or 4142 of FIGS. 3A to 8) may include a second portion (e.g., 3142b or 4142b of FIGS. 3A to 8) extending in a curved manner toward the opening (e.g., 313 or 413 of FIGS. 3A to 8) along a second direction (e.g., −X of FIGS. 3A to 8), opposite to the first direction (e.g., +X of FIGS. 3A to 8), and connected to the first portion (e.g., 3142a or 4142a of FIGS. 3A to 8).

According to an embodiment of the disclosure, the first surface (e.g., 3142 or 4142 of FIGS. 3A to 8) may include an inflection portion (e.g., 3142c or 4142c of FIGS. 3A to 8) formed at a position where the first portion (e.g., 3142a or 4142a of FIGS. 3A to 8) and the second portion (e.g., 3142b or 4142b of FIGS. 3A to 8) are connected.

According to an embodiment of the disclosure, the hole (e.g., 315 of FIGS. 3A to 8) may be formed at the second portion (e.g., 3142b of FIGS. 3A to 8).

According to an embodiment of the disclosure, the hole (e.g., 415 of FIGS. 3A to 8) may be formed in the inflection portion (e.g., 4142c of FIGS. 3A to 8).

According to an embodiment of the disclosure, a length (e.g., L1 of FIGS. 3A to 8) along which the first portion (e.g., 3142a or 4142a of FIGS. 3A to 8) extends and a length (e.g., L2 of FIGS. 3A to 8) along which the second portion (e.g., 3142b or 4142b of FIGS. 3A to 8) extends may be equal.

According to an embodiment of the disclosure, the first direction (e.g., +X of FIGS. 3A to 8) may be a flow direction of air flowing along a surface of the housing (e.g., 310 of FIGS. 3A to 8), and the hole (e.g., 315 of FIGS. 3A to 8) may be formed at the second portion (e.g., 3142b of FIGS. 3A to 8).

According to an embodiment of the disclosure, the hole (e.g., 315 of FIGS. 3A to 8) may be located between the space (e.g., 3141 of FIGS. 3A to 8) of the chamber (e.g., 314 of FIGS. 3A to 8) and the microphone (e.g., 340 of FIGS. 3A to 8), and may face a microphone hole (e.g., 341 of FIGS. 3A to 8) that is open to the microphone (e.g., 340 of FIGS. 3A to 8).

According to an embodiment of the disclosure, the first surface (e.g., 3142 of FIGS. 3A to 8) may face the grill (e.g., 330 of FIGS. 3A to 8).

According to an embodiment of the disclosure, the grill (e.g., 330 of FIGS. 3A to 8) may include a plurality of through-holes (e.g., 331 of FIGS. 3A to 8) into which air flowing along a surface of the housing (e.g., 310 of FIGS. 3A to 8) flows and which face the first surface (e.g., 3142 of FIGS. 3A to 8).

According to an embodiment of the disclosure, the first surface (e.g., 3142 of FIGS. 3A to 8) may be a portion of a surface of a spherical body (e.g., C of FIGS. 3A to 8) obtained by rotating an ellipse around a rotation axis (e.g., RX of FIGS. 3A to 8).

According to an embodiment of the disclosure, an eccentricity of the ellipse may be within a range of 0.65 to 0.9.

According to an embodiment of the disclosure, the housing (e.g., 310 of FIGS. 3A to 8) may include a first housing (e.g., 311 of FIGS. 3A to 8) in which the microphone (e.g., 340 of FIGS. 3A to 8) is disposed.

According to an embodiment of the disclosure, the housing (e.g., 310 of FIGS. 3A to 8) may include a second housing (e.g., 312 of FIGS. 3A to 8) in which the speaker (e.g., 390 of FIGS. 3A to 8) is disposed.

According to an embodiment of the disclosure, the chamber (e.g., 314 of FIGS. 3A to 8) may be formed in the first housing (e.g., 311 of FIGS. 3A to 8).

According to an embodiment of the disclosure, the wearable electronic device (e.g., 300 or 400 of FIGS. 3A to 8) may include a microphone (e.g., 340 or 440 of FIGS. 3A to 8) in which a microphone hole (e.g., 341 or 441 of FIGS. 3A to 8) connected to the space (e.g., 3141 or 4141 of FIGS. 3A to 8) of the chamber (e.g., 314 or 414 of FIGS. 3A to 8) is formed.

According to an embodiment of the disclosure, the chamber (e.g., 314 or 414 of FIGS. 3A to 8) may include a first surface (e.g., 3142 or 4142 of FIGS. 3A to 8), which is located between the space (e.g., 3141 or 4141 of FIGS. 3A to 8) of the chamber (e.g., 314 or 414 in FIGS. 3A to 8) and the microphone hole (e.g., 341 or 441 of FIGS. 3A to 8) and is at least partially formed convexly toward the opening (e.g., 313 or 413 of FIGS. 3A to 8).

According to an embodiment of the disclosure, the wearable electronic device (e.g., 300 or 400 of FIGS. 3A to 8) may include a hole (e.g., 315 of FIGS. 3A to 8) formed in the first surface (e.g., 3142 of FIGS. 3A to 8) and configured to connect the space (e.g., 3141 of FIGS. 3A to 8) of the chamber (e.g., 314 of FIGS. 3A to 8) to the microphone hole (e.g., 341 of FIGS. 3A to 8).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

1. A wearable electronic device comprising:
a housing comprising an opening in a surface thereof and a chamber defining a space facing the opening;
a speaker inside the housing and configured to output sound toward a port at a position spaced apart from the opening;
a grill at the opening; and
a microphone configured to receive sound from outside the housing,
wherein the chamber comprises:
a first surface that is at least partially convex toward the opening; and
a hole at the first surface and configured to connect the space inside the chamber with the microphone.

2. The wearable electronic device of claim 1, wherein the chamber is recessed from the surface of the housing.

3. The wearable electronic device of claim 1, wherein the chamber further comprises:
a second surface extending from the first surface toward the opening; and
a third surface extending from the first surface toward the opening and spaced apart from the second surface.

4. The wearable electronic device of claim 3, wherein at least a portion of each of the second surface and the third surface is straight.

5. The wearable electronic device of claim 1, wherein the first surface comprises:
a first portion extending in a first direction;
a second portion extending in a second direction opposite to the first direction, the second portion being connected to the first portion; and
an inflection portion at a position where the first portion and the second portion are connected.

6. The wearable electronic device of claim 5, wherein the hole is in the second portion.

7. The wearable electronic device of claim 5, wherein the hole is at least partially in the inflection portion.

8. The wearable electronic device of claim 5, wherein a length of the first portion along the first direction is equal to a length of the second portion along the second direction.

9. The wearable electronic device of claim 5, wherein the first direction corresponds to a flow direction of air that flows along the surface of the housing, and
wherein the hole is in the second portion.

10. The wearable electronic device of claim 1, wherein the hole is at a position between the space of the chamber and the microphone, and faces a microphone hole of the microphone.

11. The wearable electronic device of claim 1, wherein the first surface faces the grill.

12. The wearable electronic device of claim 1, wherein the grill comprises a plurality of through-holes through which air flowing along a surface of the housing flows.

13. The wearable electronic device of claim 1, wherein a curvature of the first surface is determined based on a portion of a surface of a spherical body formed by rotating an ellipse around a rotation axis.

14. The wearable electronic device of claim 13, wherein an eccentricity of the ellipse is within a range of 0.65 to 0.9.

15. The wearable electronic device of claim 1, wherein the housing comprises:
a first housing in which the microphone is provided; and
a second housing in which the speaker is provided, and
wherein the chamber is in the first housing.

16. A wearable electronic device, comprising:
a housing comprising an opening and a chamber facing the opening;
a grill on the opening; and
a microphone below the chamber in a first direction,
wherein the chamber comprises:
a first surface that protrudes toward the opening in a second direction that is opposite to the first direction; and
a hole in the first surface at a position corresponding to the microphone and connecting the microphone with the chamber.

17. The wearable electronic device of claim 16, wherein the first surface is a curved surface comprising a first portion that curves towards the opening in a third direction intersecting the first direction, a second portion that curves toward the opening in a fourth direction that is opposite to the third direction, and an inflection portion where the first portion and the second portion meet.

18. The wearable electronic device of claim 17, wherein the hole is spaced apart from the inflection portion of the first surface in the third direction.

19. The wearable electronic device of claim 17, wherein the hole is at a position that includes the inflection portion.

20. A wearable electronic device, comprising:
a housing comprising an opening and a chamber facing the opening;
a grill on the opening; and
a microphone below the chamber in a first direction,
wherein the chamber comprises:
a first surface having a curvature that protrudes toward the opening in a second direction that is opposite to the first direction; and
a hole in the first surface at a position corresponding to the microphone and connecting the microphone with the chamber,
wherein the curvature of the first surface is determined based on a portion of a surface of a spherical body formed by rotating an ellipse around a rotation axis, and
wherein an eccentricity of the ellipse is within a range of 0.65 to 0.9.
